(19) United States
(12) Patent Application Publication
(10) Pub. No.: US 2008/0272153 A1
(43) Pub. Date: Nov. 6, 2008

(54) SYSTEM AND METHOD FOR DELIVERING LIQUID TO A MOUTH OF A USER

(76) Inventors: Bruce Hochstadter, Highland Park, IL (US); Richard Isaacson, Highland Park, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/744,041

(22) Filed: May 3, 2007

(51) Int. Cl. B67D 5/00

(52) U.S. Cl. 222/373

(57) ABSTRACT

Systems and methods for delivering liquid orally to a mouth of a user are provided. The systems includes a container, a tube coupled to the container, and an oral device positionable in a mouth of a user. Liquid is containable in the container, expellable from the container, through the tube, and to the oral device. From the oral device, the liquid is expelled into a mouth of a user. The container may be an elastomeric pump for expelling liquid therefrom at a constant and predetermined rate. The oral device can be a mouth guard, a night guard, a buccal shield, or dentures. These systems and methods are helpful in treating xerostomia, otherwise known as dry mouth.

### FIELD OF THE INVENTION

The present invention relates to a liquid delivery system and, more particularly, a liquid delivery system for delivering liquids orally to a mouth of a user.

### BACKGROUND

Studies show that dry mouth or xerostomia as termed in the medical field plagues as much as 25% of the U.S. population, and many more people around the world. The affected population consists primarily of persons over the age of 65. In fact, current estimates indicate that approximately 30% of persons over the age of 65 are affected by xerostomia. Xerostomia occurs due to a lack of saliva in the mouth and can cause discomfort and difficulty in speech and eating. Some studies have shown xerostomia can lead to halitosis and a dramatic rise in the number of cavities, as the protective effect of saliva is no longer present, and can make the mucosa of the mouth more vulnerable to infection.

Xerostomia may be a sign of an underlying disease, such as Sjögren's syndrome, poorly controlled diabetes, or Eaton-Lambert syndrome. Other causes of xerostomia include side effects of drugs, medications, or alcohol, trauma to the salivary glands or their ducts or nerves, dehydration, excessive mouth breathing, previous radiation therapy, and also a natural result of aging. The vast majority of elderly individuals will suffer xerostomia to some degree. Playing or exercising a long time outside on a hot day will often cause the salivary glands to simply dry up as bodily fluids are concentrated elsewhere.

Xerostomia often has a negative effect on the lifestyle of people suffering therefrom. For example, sufferers of xerostomia are uncomfortable throughout the day and, particularly, during the evening while trying to sleep. Continual dry mouth can cause many sleepless nights.

Accordingly, a need exists for a treatment for xerostomia that will improve the lifestyle of a person suffering from xerostomia.

### SUMMARY

In some aspects, a system for delivering liquid to a mouth of a user is provided. The system includes a container for containing liquid, a tube having a first end and a second end, the first end of the tube being coupled to the container, and an oral device positionable in a mouth of a user, the second end of the tube being coupled to the oral device so that liquid from the container and tube can pass into the mouth of a user.

In some aspects, a system for delivering liquid to a mouth of a user is provided. The system includes an elastomeric pump including a housing, a bladder supported by and within the housing, an inlet in fluid communication with the bladder, and an outlet in fluid communication with the bladder, a tube having a first end and a second end, the first end of the tube being coupled to the outlet of the elastomeric pump, and an oral device positionable in a mouth of a user and including a coupler, the second end of the tube being coupled to the coupler.

In some aspects, a method for treating xerostomia is provided. The method includes providing a container, introducing liquid into the container, coupling a tube to the container, coupling the tube to an oral device positionable in a mouth of a user, and expelling liquid from the container, through the tube, and into a mouth of a user.

Other aspects of the invention will become apparent from consideration of the detailed description and accompanying drawings.

### BRIEF DESCRIPTION OF THE DRAWINGS

FIG. 1 is a perspective view of a liquid delivery system for delivering liquid to a mouth of a user.

FIG. 2 is a top perspective view of a liquid container and a portion of a tube of the liquid delivery system shown in FIG. 1, the liquid container shown in an empty condition.

FIG. 3 is a top perspective view of an oral device and a portion of a tube of the liquid delivery system shown in FIG. 1, the oral device being a night guard.

FIG. 4 is a rear view of the oral device shown in FIG. 3.

FIG. 5 is a front view of the oral device shown in FIG. 3

FIG. 6 is a top perspective view of the liquid container shown in FIG. 2 and a liquid injecting device, the liquid container being filled with liquid from the liquid injecting device and shown in a filled condition.

FIG. 7 is a top view of an alternative embodiment of an oral device of the liquid delivery system, the oral device being a buccal shield.

FIG. 8 is a top perspective view of an alternative embodiment of an oral device, the oral device being a top portion of a denture.

FIG. 9 is a top perspective view of an alternative embodiment of an oral device, the oral device being a bottom portion of a denture.

FIG. 10 is a top perspective view of an alternative embodiment of a connection between a tube and an oral device of a liquid delivery system for delivering liquid to a mouth of a user.

FIG. 11 is a top perspective view of another alternative embodiment of a connection between a tube and an oral device of a liquid delivery system for delivering liquid to a mouth of a user.

FIG. 12 is a perspective view of a liquid delivery system for delivering liquid to a mouth of a user, the system including a restrictor.

FIG. 13A is a top view of the restrictor of FIG. 12, the restrictor shown in a first condition for facilitating a first flow rate.

FIG. 13B is a top view of the restrictor of FIG. 12, the restrictor shown in a second condition for facilitating a second flow rate.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

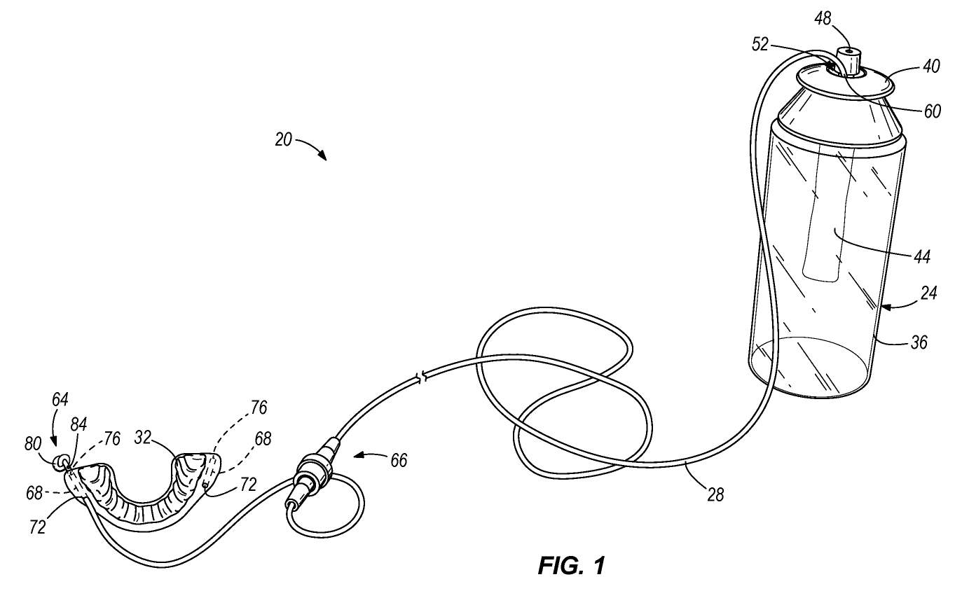

With reference to FIG. 1, a liquid delivery system 20 is illustrated and is operable to deliver a controlled flow of liquid to a mouth of a user. Such liquid delivery is valuable for people suffering from dry mouth or xerostomia, for example. Many types of liquids can be delivered orally by the liquid delivery system 20, such as, for example, water, nutrient enriched liquids, medicines, or any other ingestible liquids. The liquid delivery system 20 includes a liquid container 24, a tube 28, and an oral device 32.

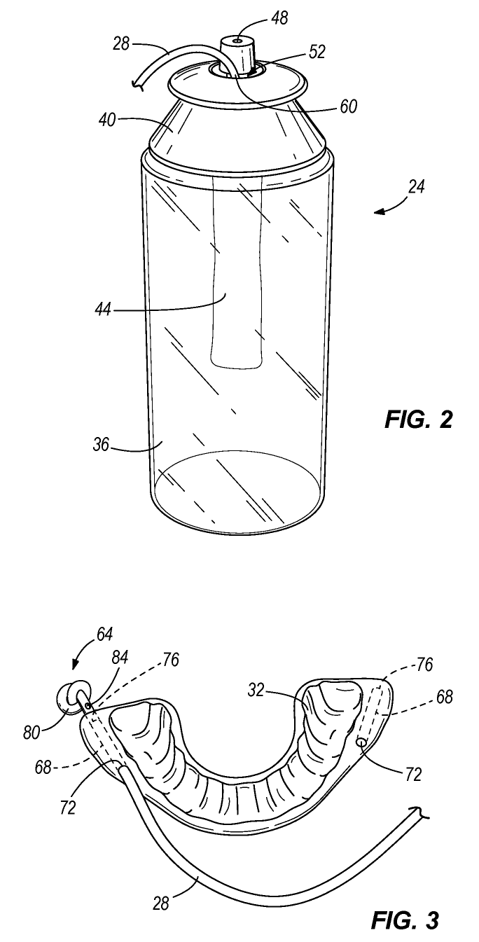

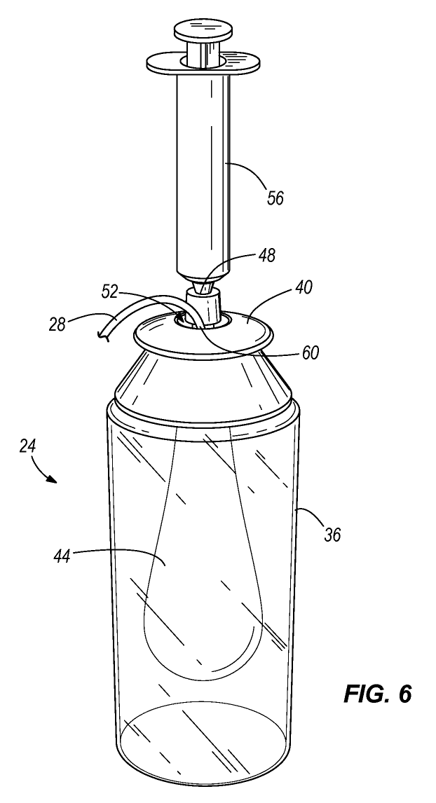

With continued reference to FIG. 1 and additional reference to FIG. 2, the liquid container 24 is operable to contain a liquid and deliver the liquid from the container 24 at a constant and predetermined rate. In the illustrated embodiment, the container 24 is an elastomeric pump capable of containing liquid and expelling liquid at a constant and predetermined rate. Alternatively, the container 24 can be other devices capable of containing liquid and expelling liquid therefrom. The container 24 includes a housing 36, a cover 40 for covering an open end of the housing 36, an elastomeric bladder 44 supported by and disposed within the housing 36, an inlet 48 positioned at a top of the housing 36 and in fluid communication with the bladder 44, and an outlet 52 positioned at the top of the housing 36 and in fluid communication with the bladder 44. Liquid is introduced into the bladder 44 via the inlet 48 by any appropriate device. For example, with reference to FIG. 6, a syringe 56 is used to inject liquid into the bladder 44 through the inlet 48. FIGS. 1 and 2 illustrate the liquid container 24 in an empty condition, in which no liquid is positioned in the bladder 44, and FIG. 6 illustrates the liquid container 24 in a filled condition, in which a sufficient amount of liquid has been injected into the bladder 44 causing the bladder 44 to deform and expand. The expanded bladder 44 applies a constant and predetermined force on the liquid therein, thereby forcing the liquid out of the bladder 44 and through the outlet 52 at a substantially constant and predetermined volume over time (“rate”). In some embodiments, the liquid container 24 is an Infusor™ manufactured by Baxter Healthcare Corporation located in Deerfield, Ill. However, other types of liquid containers can be utilized to deliver liquid at a substantially constant and predetermined rate.

With reference to FIGS. 1-3, the tube 28 includes a first end 60 coupled to and in fluid communication with the outlet 52 of the liquid container 24 and a second end 64 coupled to the oral device 32. The tube 28 is hollow and enables liquid to travel from the outlet 52 of the liquid container 24 to the oral device 32. In the illustrated embodiment, the second end 64 of the tube 28 passes completely through a tube coupler 68 such that it extends beyond an outlet 76 of the tube coupler 68 and is blocked from further liquid flow, such as by knot 80 at the second end 64. In addition to the knot 80 blocking liquid flow, the knot 80 also prevents the tube 28 from being pulled back through the tube coupler 68 and disconnecting from the oral device 32. Alternatively, the tube 28 may be blocked and prevented from disconnecting from the oral device 32 in manners other than that described and illustrated. The tube 28 has a tube aperture 84 near the knot 80 and preferably to the rear of the oral device 32. In this embodiment, the liquid remains in the tube 28 until reaching the tube aperture 84, where liquid leaks through the tube aperture 84 and into a user's mouth. The tube 28 can be a large variety of types and sizes of tubes as long as liquid is delivered from the liquid container 24 to the oral device 32 at an acceptable rate. In some embodiments, the tube 28 is a Surflo winged infusion tube (product no. SV23BLK) manufactured by Terumo Corporation of Tokyo, Japan (U.S. headquarters in Somerset, N.J.) that has an inner diameter of 1 millimeter and an outer diameter of 2 millimeters.

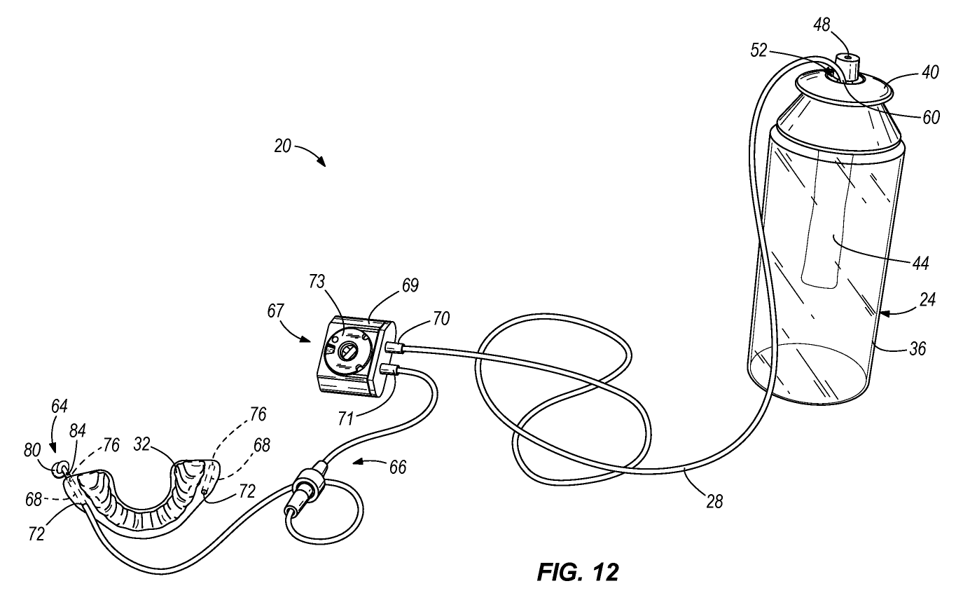

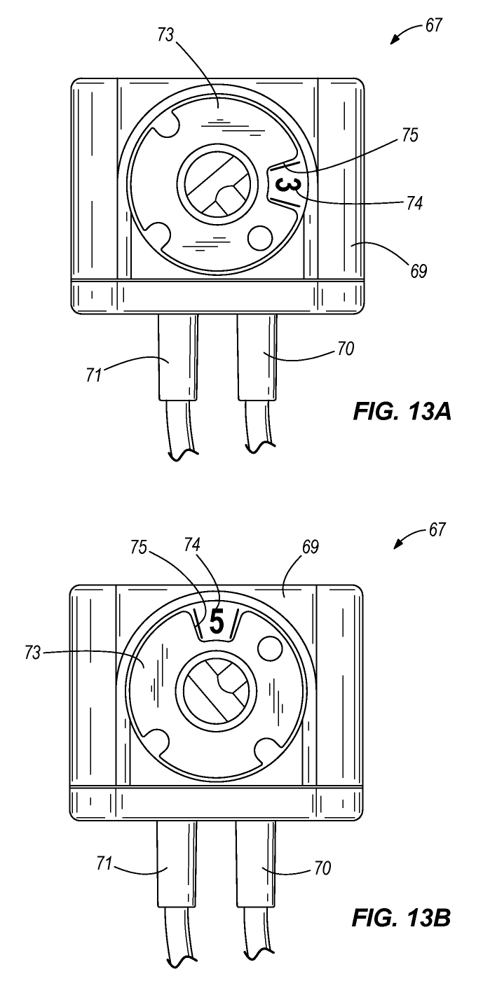

With particular reference to FIG. 1, a fitting or Luer Lok® 66 is disposed along the tube 28. In the illustrated embodiment, the tube 28 is separated into two portions. The fitting 66 joins the two portions of the tube together and acts as a valve to assist in controlling the flow of liquid from one portion of the tube to the other and, ultimately, to control the flow of liquid from the container 24 to the oral device 32. In some embodiments, the fitting 66 controls the flow of liquid from the container 24 to the oral device 32 at a single, constant rate. Liquid delivery rates of 2 cubic centimeters (cc) or 5 cubic centimeters per hour are thought to be helpful for some users. Alternatively, the rate at which the liquid is delivered from the bladder 44 can be another desired rate, depending on the liquid demand or needs of the patient. In other embodiments and with reference to FIGS. 12, 13A, and 13B, the system can include a restrictor 67 for adjusting the flow of liquid from the container 24 to the oral device 32. The restrictor 67 can be connected to or unitary with the fitting 66, or can be separate from the fitting 66 and disposed along the tube 28 at a distance from the fitting 66 (as shown in the illustrated embodiment). In embodiments where the system 20 includes a restrictor 67 to control liquid flow rate, the fitting 67 does not assist in controlling liquid flow rate. Rather, the fitting 67 is used solely to couple the first and second portions of the tube 28 together. The restrictor 67 includes a housing 69, a restrictor inlet 70, a restrictor outlet 71, a rotatable dial 73, and indicia 74 associated with various liquid flow rates. A user rotates the dial 73 to the desired flow rate and ceases rotation of the dial 73 when the desired indicium 74 is in the dial window 75. FIG. 13A shows a 3 cc per hour condition, which allows 3 cc of liquid per hour to flow from the container 24 to the oral device 32. FIG. 13B shows a 5 cc per hour condition, which allows 5 cc of liquid per hour to flow from the container 24 to the oral device 32. The restrictor 67 can include numerous additional settings than the two settings illustrated and described in order to facilitate greater adjustability of flow rates. Additionally, the restrictor 67 can have other flow rate values from those illustrated and described. In some embodiments, the system 20 may not include a fitting positioned along the tube 28 and may only include a restrictor 67. In other embodiments, the system 20 may not include a fitting or a restrictor, in which case the tube 28 may be a single, continuous tube extending between the container 24 and the oral device 32.

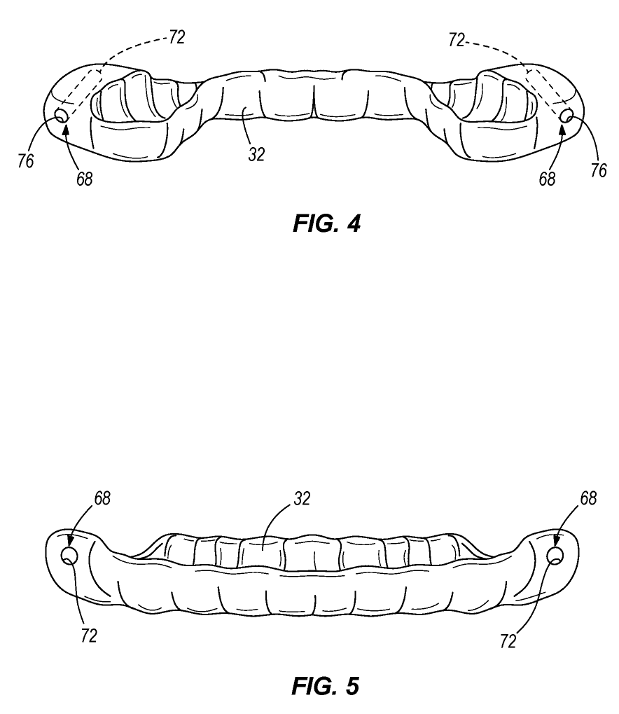

With reference to FIGS. 1 and 3-5, an oral device 32 is illustrated and includes a pair of tube couplers 68 through respective portions of the oral device 32. In this case, the oral device 32 is a mouth guard and the couplers are apertures opposite each other and located at the rear ends of the mouth guard. Alternatively, the apertures may be located elsewhere on the oral device 32, and the oral device 32 may include only one coupler 68. Each aperture 68 includes an oral inlet 72 and an oral outlet 76. The second end 64 of the tube 28 can be coupled to either one of the apertures 68 to deliver liquid to the selected aperture 68. Preferably, the outlets 76 are located further from the lips than the inlets 72. Liquid delivered from the container 24 to the oral device 32 moistens the interior of the user's mouth, thereby relieving some or all of the discomforts of dry mouth.

With continued reference to FIGS. 1 and 3-5, the oral device 32 is a mouth guard typically worn by users during sleep. Such mouth guards inhibit teeth grinding, cheek biting, and other issues that arise during sleep. These types of mouth guards are commonly referred to as night guards and are made by a variety of manufactures.

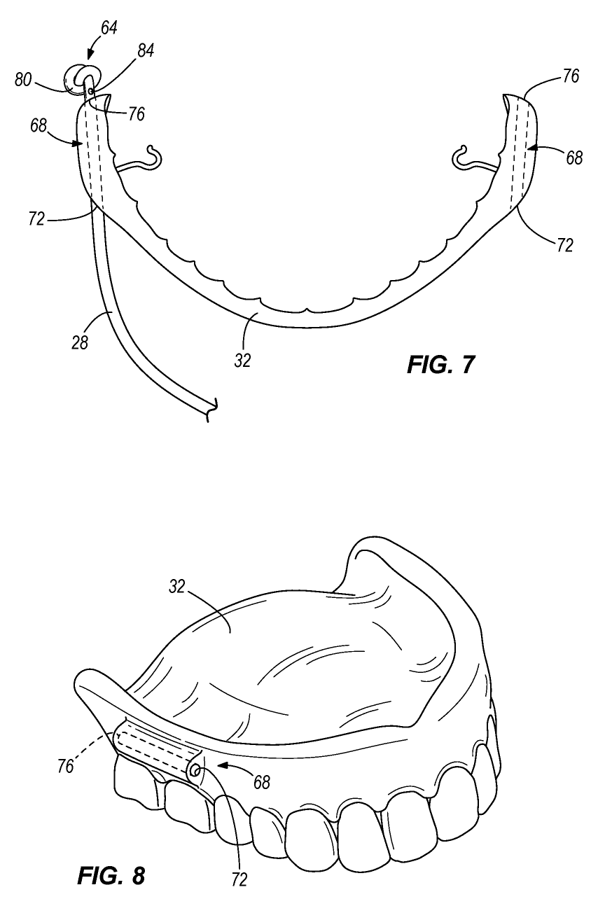

With reference to FIG. 7, an alternative embodiment of an oral device 32 is illustrated. In this embodiment, the oral device 32 is a buccal shield. Similarly to the mouth guard, the buccal shield includes two couplers or apertures 68, one on each side, for receiving the second end 64 of the tube 28. Alternatively, the apertures 68 may be located elsewhere on the buccal shield, and the buccal shield may include only one coupler.

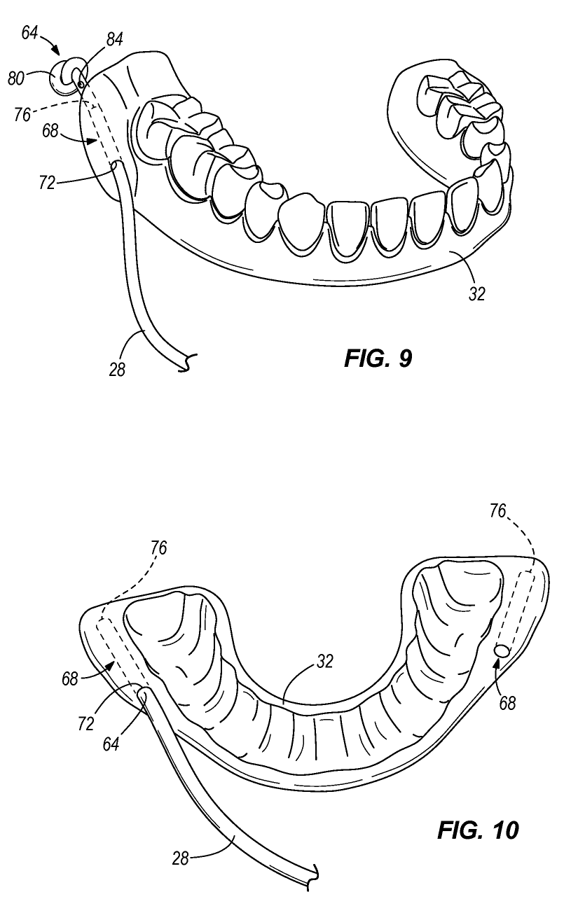

Referring now to FIGS. 8 and 9, another alternative embodiment of the oral device 32 is illustrated. In this embodiment, the oral device 32 is dentures. FIG. 8 shows a top denture and FIG. 9 shows a bottom denture. Either or both the top and the bottom dentures can include a coupler or aperture 68 for receiving the second end 64 of the tube 28. Also, either or both sides of the top denture and either or both sides of the bottom denture can include a coupler or aperture 68 for receiving the second end 64 of the tube 28.

With reference to FIGS. 1 and 6, operation of the liquid delivery system 20 will be described. A user first fills an injecting device 56 (a syringe as illustrated) with a desired liquid. The syringe 56 is then inserted into the inlet 48 of the liquid container 24 and the plunger of the syringe 56 is depressed to inject the liquid into the bladder 44 of the liquid container 24. This step is repeated until the bladder 44 contains the desired amount of liquid. A user then inserts the oral device 32 into his/her mouth. The liquid container 24 and fitting 66 are configured to deliver liquid to the oral device 32 at a substantially constant and predetermined rate. The liquid is expelled from the bladder 44 through the outlet 52 of the liquid container 24 and travels into and through the tube 28 and fitting 66 to the oral device 32. From the oral device 32, liquid enters and moistens the user's mouth. A person can use the liquid delivery system 20 while awake or sleeping.

With reference to FIG. 10, an alternative manner of coupling the tube 28 to the oral device 32 is illustrated. In this embodiment, the tube 28 is coupled to the oral device 32 by inserting end 64 of the tube 28 into the inlet 72 of the aperture 68 and press-fitting, friction-fitting, or interference-fitting the tube 28 in the aperture 68. The liquid container 24 delivers liquid therefrom and the liquid travels through the tube 28, into the inlet 72 of the aperture 68, and out of the outlet 76 of the aperture 68. From the outlet 76 of the aperture 68, the liquid is introduced into a mouth of a user.

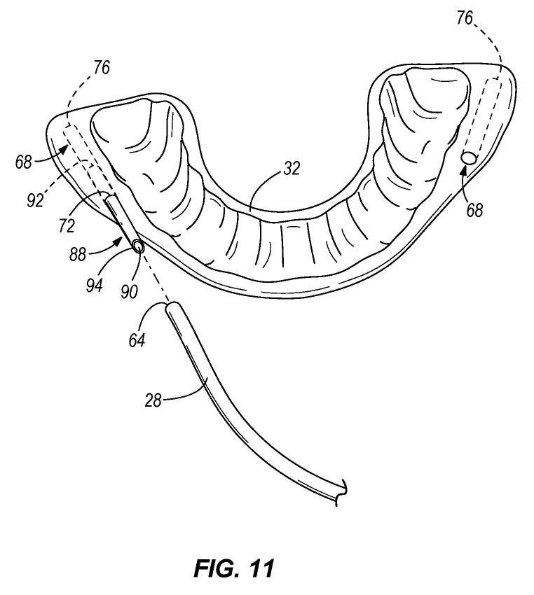

With reference to FIG. 11, another alternative manner of coupling the tube 28 to the oral device 32 is illustrated. In this embodiment, a hollow needle or pipe 88 is used to couple the tube 28 to the oral device 32. The pipe 88 has an inner passage 90 to allow liquid to pass there through, a first end 92 coupled to the second end 64 of the tube 28, and a second end 94 coupled to the oral device 32. The second end 64 of the tube 28 can be slid over the first end of the pipe 88 and secured via a press-fit, friction-fit, interference-fit, or the like. Liquid travels through the tube 28, into and through the pipe 88, into the aperture 68, and out of the outlet 76 of the aperture into a user's mouth.

The various oral devices shown and described herein are only a sample of the oral devices useable in the liquid delivery system. The liquid delivery system can utilize any type of oral device appropriate for receiving a tube and liquid flowing from the tube. Accordingly, the present invention is not meant to be limited to those oral devices specifically disclosed herein, but, rather, to include other types of oral devices appropriate for use with the liquid delivery system.

It should be understood that a large variety of alternatives and variations exist to the embodiments discussed above and illustrated in the drawings. One of ordinary skill in the art will be able to recognize such alternatives and variations from the disclosure herein and, therefore, such alternatives and variations are within the spirit and scope of the present invention.

What is claimed is:

1. A system for delivering liquid to a mouth of a user, the system comprising:
a container for containing liquid;
a tube having a first end and a second end, the first end of the tube being coupled to the container; and
an oral device positionable in a mouth of a user, the second end of the tube being coupled to the oral device so that liquid from the container and tube can pass into the mouth of a user.

2. The system of claim 1, wherein the container is pressurized and a pressure is applied to the liquid contained in the container such that the liquid is expelled from the container at a substantially constant rate.

3. The system of claim 1, wherein the container includes:
a housing, and
a bladder for receiving and expelling liquid supported by the housing.

4. The system of claim 3, wherein the container further comprises an inlet and an outlet in fluid communication with the bladder.

5. The system of claim 4. wherein the first end of the tube is coupled to and in fluid communication with the outlet of the container.

6. The system of claim 3, wherein the bladder is made of an elastomeric material.

7. The system of claim 1, wherein the oral device has a coupler including an inlet and an outlet, the second end of the tube being coupled to the inlet.

8. The system of claim 7, wherein the coupler is a first coupler, and the oral device has a second coupler, each of said first and second couplers having an inlet and an outlet, the second end of the tube being selectively couplable to either the inlet of the first coupler or the inlet of the second coupler.

9. The system of claim 1, wherein the oral device has a coupler including an inlet and an outlet, the second end of the tube is inserted into and through the coupler such that the second end projects beyond the outlet of the coupler, the second end of the tube being blocked and having a tube aperture, liquid being expellable from the tube via the tube aperture.

10. The system of claim 9, wherein the second end of the tube has a knot

11. The system of claim 1, wherein the oral device is a mouth guard.

12. The system of claim 1, wherein the oral device is a night guard.

13. The system of claim 1, wherein the oral device is a buccal shield.

14. The system of claim 1, wherein the oral device is a denture.

15. The system of claim 1, wherein the container is an elastomeric pump.

16. The system of claim 1, wherein the tube includes a first portion and a second portion, the system further comprising a fitting joining the first and second portions of the tube together.

17. The system of claim 1, further comprising a restrictor coupled to the tube, the restrictor operable to adjust a flow rate of the liquid.

18. The system of claim 1, wherein the oral device has a coupler including an inlet and an outlet, and the system further comprising a hollow pipe coupled to the inlet of the coupler, the second end of the tube being coupled to the hollow pipe.

19. A system for delivering liquid to a mouth of a user, the system comprising:
an elastomeric pump including a housing, a bladder supported by and within the housing, an inlet in fluid communication with the bladder, and an outlet in fluid communication with the bladder;
a tube having a first end and a second end, the first end of the tube being coupled to the outlet of the elastomeric pump; and
an oral device positionable in a mouth of a user and including a coupler, the second end of the tube being coupled to the coupler.

20. The system of claim 19, wherein the bladder is made of an elastomeric material.

21. The system of claim 19, wherein the coupler is a first coupler, the oral device including a second coupler, the second end of the tube being selectively couplable to either the first coupler or the second coupler.

22. The system of claim 21, wherein the second end of the tube is inserted into and through the selected one of the first and second coupler such that the second end projects beyond the selected coupler, the second end of the tube being blocked and having a tube aperture.

23. The system of claim 22, wherein the second end of the tube has a knot.

24. The system of claim 19, wherein the oral device is a mouth guard.

25. The system of claim 19, wherein the oral device is a night guard.

26. The system of claim 19, wherein the oral device is a buccal shield.

27. The system of claim 19, wherein the oral device is a denture.

28. A method for treating xerostomia comprising:
providing a container;
introducing liquid into the container;
coupling a tube to the container;
coupling the tube to an oral device positionable in a mouth of a user; and
expelling liquid from the container, through the tube, and into a mouth of a user.

29. The method of claim 28, wherein providing a container includes providing an elastomeric pump including a housing, a bladder supported by and within the housing, an inlet in fluid communication with the bladder, and an outlet in fluid communication with the bladder.

30. The method of claim 29, wherein introducing liquid into the container includes introducing liquid into the container through the inlet and into the bladder, and wherein expelling liquid from the container includes expelling liquid from the container through the outlet.

31. The method of claim 28, wherein the oral device includes a coupler, and wherein coupling the tube to the oral device includes coupling the tube to the coupler of the oral device.
